(19) United States
(12) Patent Application Publication
(10) Pub. No.: US 2009/0189319 A1
(43) Pub. Date: Jul. 30, 2009

(54) Process of preparing continuous filament composed of nanofibers

(76) Inventor: Hak-Yong Kim, Chonrabuk-do (KR)

Correspondence Address: BIRCH STEWART KOLASCH & BIRCH, PO BOX 747, FALLS CHURCH, VA, 22040-0747, US

(21) Appl. No.: 10/585,333

(22) PCT Filed: Feb. 2, 2004
(86) PCT No.: PCT/KR04/00188

§ 371 Date: Jul. 6, 2006

(51) Int. Cl. H05B 7/00

(52) U.S. Cl. 264/484; 977/755

(57) ABSTRACT

Conventional electrospinning was problematic in that it is incapable of making a continuous filament (yarn) by a simple and continuous process. To solve the above problem, there is provided a method for making a continuous filament consisting of nanofibers according to the present invention, wherein a polymer spinning liquid is electrostatically spun to a collector 7 through nozzles 5 to obtain a nanofiber web 17a of ribbon form, then the nanofiber web 17a is passed through an air twister 18 and twisted to obtain a nanofiber filament 17b of a continuous filament form, and then the nanofiber filament 17b is drawn.

### TECHNICAL FIELD

The present invention relates to a process of preparing a continuous filament or yarn (hereinafter, referred to as ‘filament’) composed of nanofibers, and more particularly, to a process of preparing a continuous filament by a continuous process by using electrospinning.

In the present invention, nanofibers indicate fibers having a fiber diameter of less than 1,000 nm, and more preferably, less than 500 nm.

A nonwoven fabric or the like consisting of nanofibers is variously utilizable as artificial leather, filter, diaper, sanitary pad, suture, adhesion preventive agent, wiping cloth, artificial vessel, bone fixture, etc., especially, very useful for the production of artificial leather.

### BACKGROUND ART

As conventional techniques for making ultrafine fibers or nanofibers suitable to make artificial leather or the like, sea-island type conjugated spinning, split type conjugated spinning, blend spinning and so one are known.

In the case of the sea-island type conjugated spinning or blend spinning, however, one of two polymer components constituting a fiber must be eluted and removed for making fibers ultrafine. In order to make artificial leather using fibers made by these methods, complicated processes, such as melt spinning, fiber making, nonwoven fabric making, urethane impregnation and one component dissolution, should be carried out. Nevertheless, it is impossible to make fibers with a diameter less than 1,000 nm by using the above two methods.

Meanwhile, in the case of the split type conjugated spinning, two polymer components (for example, polyester and polyamide) different in dyeing property coexist in fibers, thus dyeing unevenness is produced and an artificial leather making process becomes complicated. Besides, it is difficult to make fibers with a diameter less than 2,000 nm by using the above method.

As another conventional technique for making nanofibers, U.S. Pat. No. 4,323,525 and the like proposes an electrospinning method. In the prior art electrospinning method, a polymer spinning liquid in a spinning liquid main tank is continuously quantitatively fed through a metering pump into a plurality of nozzles having a high voltage, and then the spinning liquid fed into the nozzles is spun and collected on a collector of endless belt type having a high voltage more than 5 kV, thereby making a fiber web. The fiber web thus made is needle-punched in the next process to make a nonwoven fabric consisting of nanofibers.

As seen from above, the prior art electrospinning method is only capable of making a web and nonwoven fabric consisting of nanofibers less than 1,000 nm. Therefore, in order to make a continuous filament by the conventional electrospinning method, the made nanofiber web needs to be cut to a certain length to make a single fiber, and then needs to be blown to undergo a separate spinning process, thus making the process complicated.

In the case of a nonwoven fabric consisting of nanofibers, there is a limit to applying it to a wide range of various fields of applications like artificial leather due to limits of physical property characteristic of a nonwoven fabric. For reference, in the case of a nonwoven fabric consisting of nanofibers, it is hard to achieve a physical property higher than 10 MPa.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a process schematic diagram of the present invention according to upward electrospinning for making narrow webs separated in units of nozzle block;

FIG. 2 is an enlarged pattern diagram of a collector 7 portion of FIG. 1;

FIG. 3 is an enlarged pattern diagram of a process of twisting the narrow webs of FIG. 1 by an air twister 18;

FIG. 4 is a process schematic diagram of the present invention according to upward electrospinning for making a wide web by using a web separating film or a nonwoven fabric 24;

FIG. 5 is an enlarged pattern diagram of a process for cutting the wide web of FIG. 4 by a web cutter 16 and twisting the same by an air twister 18;

FIG. 6 is an enlarged pattern diagram of a process for cutting the wide web by a rotary blade 16a of the web cutter;

FIGS. 7 to 9 are process schematic diagrams of the present invention according to upward electrospinning for coating or spraying a nanofiber separating solution 27 onto a collector 7;

FIG. 10 is a schematic view showing a process of the present invention for making a hybrid type nanofiber filament;

FIG. 11 is an electron micrograph of a nanofiber filament made in Example 1;

FIG. 12 is an electron micrograph of a nanofiber filament made in Example 2;

FIG. 13 is a schematic view of a nozzle block 4 used in upward electrospinning;

FIG. 14(a) is a cross sectional view of a spinning liquid dropping device 3 used in upward electrospinning; and

FIG. 14(b) is a perspective view of the spinning liquid dropping device 3 used in upward electrospinning.

### EXPLANATION OF REFERENCE NUMERALS FOR THE MAIN PARTS OF THE DRAWINGS

1: spinning liquid main tank
2: metering pump
3: spinning liquid dropping device
3a: filter of spinning liquid dropping device
3b: gas inlet pipe
3c: spinning liquid induction pipe
3d: spinning liquid discharge pipe
4: nozzle block
4b: nozzle circumferential hole
4c: insulator plate
4d: spinning liquid temporary storage plate
4e: nozzle plate
4f: spinning liquid main feed plate
4g: heating device
4h: conductive plate
5: nozzle
6: nanofiber
7: collector (conveyer belt)
7b: barriers of collector
8a,8b: collector supporting roller
9a: voltage generator
9b: discharge device
10: nozzle block bilateral reciprocating device
11a: motor for stirrer
11b: nonconductive insulating rod
11c: stirrer
12: spinning liquid discharge device
13: feed pipe
14, 15: web supporting roller
16: web cutter
16a: rotary blade of web cutter
16b: motor for rotary blade
17a: nanofiber web
17b: nanofiber filament
18: air twister
19: first roller
20: second roller
21: thermosetting heater
22: third roller
23: filament take-up roller
24: nanofiber web separating film or nonwoven fabric
24a: film or nonwoven fabric feed roller
25: nanofiber web separating solution feed roller
27: nanofiber web separating solution
28: nanofiber web separating solution sprayer
h: distance from collector to discharge device
u: width of web spun with width of one nozzle block
d: distance between barriers in collector (unit collector distance)

### DISCLOSURE OF THE INVENTION

The present invention provides a process of preparing a filament (yarn) continuously by using an electrospun spun nanofiber web without any particular spinning process, in order to make a continuous filament consisting of nanofibers by a simple process. Furthermore, the present invention provides a method for making a continuous filament consisting of nanofibers which are suitable as materials for various fields of industry such as artificial leather, filter, diaper, sanitary pad, artificial vessel, etc. because of excellent physical properties.

To achieve the above objects, there is provided a process of preparing a continuous filament consisting of nanofibers according to the present invention, wherein a polymer spinning liquid is electrostatically spun to a collector 7 through nozzles 5 to obtain a nanofiber web 17a of ribbon form, then the nanofiber web 17a is passed through an air twister 18 and twisted to obtain a nanofiber filament 17b of a continuous filament form, and then the nanofiber filament 17b is drawn.

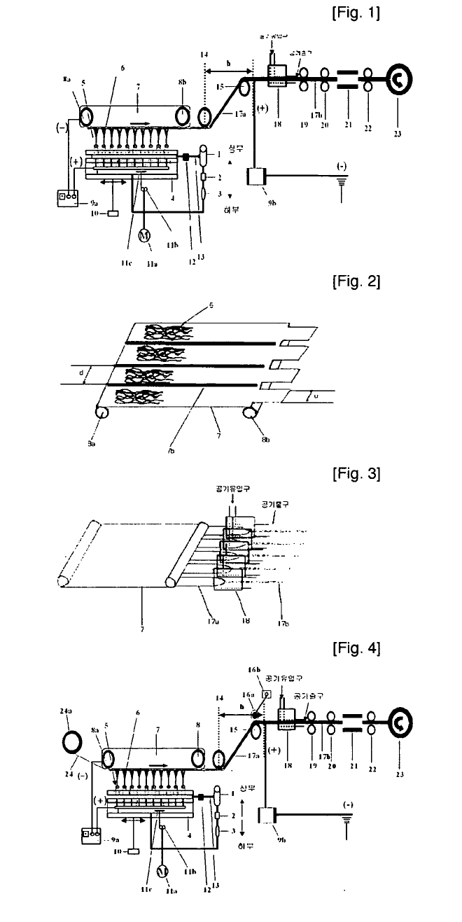

Hereinafter, the present invention will be described in detail with reference to the accompanying drawings. In the present invention, firstly, as shown in FIGS. 1, 4 and 7 to 10, a nanofiber web 17a of ribbon type is made by electrostatically spinning a polymer spinning liquid to a collector 7 through nozzles 5.

To make the nanofiber web 17a of ribbon type, can be used (I) a method of wide electrospinning in a manner that the width of a nanofiber web 17a is the same as the overall width of a collector 7 and then cutting the wide nanofiber web 17a by a web cutter 16, or (II) a method of electrospinning in narrow sections in a manner the width of a nanofiber web 17a is the same as the width of one nozzle block 4.

The web cutter 16 for cutting the wide nanofiber web 17a to a narrow width consists of a rotary blade 16a and a motor 16b rotating the rotary blade 16a as shown in FIG. 6, and is installed on a web feed roller 15 as shown in FIG. 4.

FIG. 6 is an enlarged pattern diagram of a process for cutting the wide nanofiber web 17a by a web cutter 16.

Meanwhile, to electrostatic spin in narrow sections so that the width of a nanofiber web 17a is the same as the width of one nozzle block 4, as shown in FIG. 2, a collector 7 with barriers 7b installed thereto at the same distance d as the width of one nozzle block 4 is used. FIG. 2 is an enlarged pattern diagram of a collector 7 portion of FIG. 1 with barriers 7b installed thereto.

Preferably, the barriers 7b are electric insulators like Teflon.

The nanofiber web 17a having passed through web feed rollers 14 and 15 has a strong charge.

Afterwards, in order to carry out a continuous filament making process smoothly, it is preferred to discharge the charge of the nanofiber web 17a by using a discharge device 9b.

The distance h between the collector and the discharge device is properly set considering the width of the nanofiber web and the like.

Continually, in the present invention, as shown in FIGS. 1, 4 and 7 to 10, the nanofiber web 17a of ribbon form thus obtained is twisted by air turbulence while passing through an air twister 18, thereby making a nanofiber filament 17b of a continuous filament shape.

FIG. 3 is an enlarged pattern diagram of a process of making a nanofiber filament 17b by twisting a nanofiber web 17a electrostatically spun in units of width, i.e., into narrow sections, while passing it through an air twister 18.

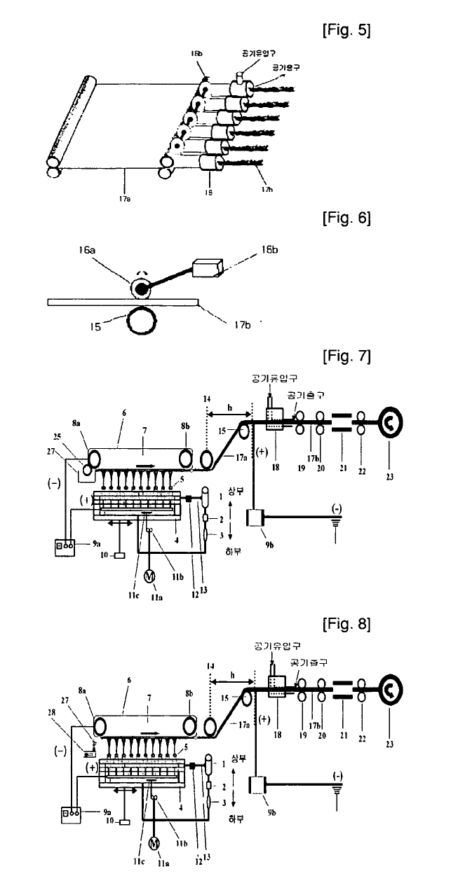

FIG. 5 is an enlarged pattern diagram of a process of making a nanofiber filament 17b by cutting a nanofiber web 17a with the web cutter 16 electro statically spun widely with the same width as the overall width of the collector and twisting it while passing it through an air twister 18.

The air twister 18 is a structure in which a passage of the nanofiber web 17a and an air outlet are formed at the center along the longitudinal direction and an air inlet is formed in a direction perpendicular or inclined to the air outlet.

More preferably, the air inlet has a spiral hole structure.

The nanofiber web 17b passing through the air twister 18 becomes a continuous filament form, with nanofibers constituting the web being crosslinked and twisted one another by air turbulence in the air twister 18.

Continually, in the present invention, as shown in FIGS. 1, 4 and 7 to 10, the nanofiber filament 17b thus obtained is drawn and taken up to be made into a final product, i.e., a continuous nanofiber filament. After the drawing, heat treatment may be optionally carried out.

Specifically, the nanofiber filament 17b is drawn between a first roller 19 and a second roller 20 or between the second roller 20 and a third roller 22 by using a gap in rotation linear velocity between the rollers. Then, the nanofiber filament 17b is heat treated by a thermosetting heater 21 installed between the second roller 20 and the third roller 22 and then taken up by a take-up roller 23.

The making method of the present invention can be applied to all of upward electrospinning, downward electrospinning and horizontal electrospinning.

Namely, the present invention includes every method of which electrospinning type is upward electrospinning type, downward electrospinning type or horizontal electrospinning type.

In the present invention, the horizontal electrospinning is referred to as the method of electrospinning with nozzles and a collector arranged horizontally or nearly horizontally.

FIGS. 1, 4 and 7 to 10 are all schematic views of a process of the present invention according to the upward electrospinning.

Specifically, FIG. 1 is a schematic chart of a process of the present invention in which a narrow nanofiber web is obtained by using a collector 7 with barriers 7b installed at a predetermined interval as shown in FIG. 2 in an upward electrospinning, and then made into a nanofiber filament.

Meanwhile, FIG. 4 is a schematic chart of a process of the present invention in which a wide nanofiber web is obtained by using a collector 7 with no barriers 7b installed in an upward electrospinning, and the wide nanofiber web is cut to a narrow width by a web cutter 16 and then made into a nanofiber filament.

In order to easily separate the nanofiber web 17a formed on the surface of the collector 7 of the present invention from the collector 7, it is preferred to continuously feed a nanofiber web separating film or a nonwoven fabric 24 form a film or nonwoven fabric feed roller 24a onto the surface of the collector 7 where nanofibers are electrostatically spun as shown in FIG. 4, or it is preferred to continuously or discontinuously coat or spray a nanofiber web separating solution 27 onto the collector 7 as shown in FIGS. 7 to 9.

The nanofiber web separating solution 27 is water, a cationic surfactant, an anionic surfactant, an amphoteric (cationic-anionic) surfactant, or a neutral surfactant.

Additionally, as the web separating solution, can be used solvents like ethanol, methanol, benzene, methylene chloride, toluene, etc.

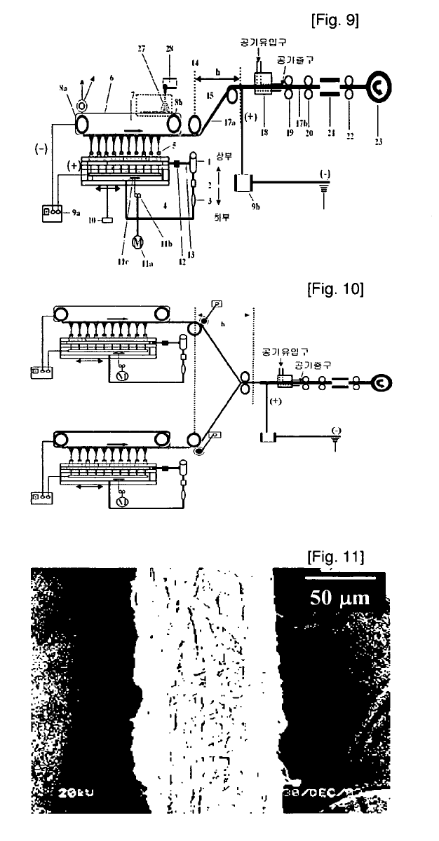

FIG. 7 is a schematic view of a process of the present invention employing the method of coating a nanofiber web separating solution 27 on a collector by using a feed roller 25. FIG. 8 is a schematic chart of a process of the present invention employing the method of spraying a nanofiber web separating solution in an upward direction from the bottom of a collector by using a sprayer 28. FIG. 9 is a schematic chart of a process of the present invention employing the method of spraying a nanofiber web separating solution 27 in a downward direction from the top of a collector by using a sprayer 28.

In the event that the nanofiber web separating solution 27 is coated or sprayed onto the collector 7 in electrospinning as stated above, the discharging treatment process may be omitted according to the material of nanofibers.

In the case of employing the method of making a narrow nanofiber web in units of the width of one nozzle block, the effect of coating or spraying the nanofiber web separating solution 27 onto the collector 7 as seen from above is more remarkable.

Meanwhile, the present invention includes a method of making a hybrid type nanofiber filament by obtaining more than two kinds of nanofiber webs 17a of ribbon form by electrostatically spinning more than two kinds of spinning liquids by respective electrospinning machines and then passing them through one air twister 18. FIG. 10 is a schematic view showing a process of the present invention for making a hybrid nanofiber web, and reference numerals in the drawing are omitted.

In the case that the nanofiber filament is hybrid, it is advantageous in that the physical properties of individual fibers constituting the web can be supplemented.

The upward spinning apparatuses as shown in FIG. 1 and the like each comprises: a spinning liquid main tank 1 for storing a spinning liquid; a metering pump 2 for quantitatively feeding the spinning liquid; an upward nozzle block 4 having nozzles 5 consisting of a plurality of pins assembled in a block shape and for discharging the spinning liquid onto fibers; a collector 7 located above the nozzle block and for collecting single fibers being spun; a voltage generator 19a for generating a high voltage; and a spinning liquid discharge device 12 being connected to the topmost part of the nozzle block.

As shown in FIG. 13, the nozzle block 4 includes: [I] a nozzle plate 4e with nozzles 5 arranged thereon; [II] nozzle circumferential holes 4b surrounding the nozzles 5; [III] a spinning liquid temporary feed plate 4d connected to the nozzle circumferential holes 4b and located right above the nozzle plate 4e; [IV] an insulator plate 4c located right above the spinning liquid temporary feed plate 4d; [V] a conductive plate 4h having pins arranged thereon in the same way as the nozzles are and located right below the nozzle plate 4e; [VI] a spinning liquid main feed plate 4f including the conductive plate 4h therein; [VII] a heating device 4g located right below the spinning liquid main feed plate 4f; and [VIII] a stirrer 11c installed within the spinning liquid main feed plate 4f.

A plurality of nozzles 5 in the nozzle block 4 are arranged on the nozzle plate 4e, and nozzle circumferential holes 4b surrounding the nozzles 5 are installed on the outer parts of the nozzles 5.

The nozzle circumferential holes 4b are installed for the purpose of preventing a droplet phenomenon which occurs in the event that an excessive quantity of a spinning liquid formed in the nozzle 5 outlets are not all made into fibers and recovering an overflowing spinning liquid, and play the role of gathering the spinning liquids not made into fibers at the nozzle outlets and feeding them to the spinning liquid temporary feed plate 4d located right above the nozzle plate 4e.

Of course, the nozzle circumferential holes 4b have a larger diameter than the nozzles 5 and preferably formed of an insulating material.

The spinning liquid temporary feed plate 4d is made from an insulating material and plays the role of temporally storing the residual spinning liquid introduced through the nozzle circumferential holes 4b and feeding it to the spinning liquid main feed plate 4f.

An insulator plate 4c is installed right above the spinning liquid temporary feed plate 4d and plays the role of protecting the nozzle top part so that spinning can be smoothly done only in the nozzle regions.

The conductive plate 4h with pins arranged in the same manner as the nozzles are is installed right below the nozzle plate 4e, and the spinning liquid main feed plate 4f including the conductive plate 4h is installed.

Further, the heating device 4g of direct heating type is installed right below the spinning liquid main feed plate 4f.

The conductive plate 4h plays the role of applying a high voltage to the nozzles 5, and the spinning liquid main feed plate 4f plays the role of storing a spinning liquid introduced from the spinning liquid dropping devices 3 to the spinning block 4 then supplying it to the nozzles 5. At this time, the spinning liquid main feed plate 4f is preferably produced to occupy a minimum space so as to minimize the storage amount of the spinning liquid.

Meanwhile, the spinning liquid dropping device 3 of the present invention is overally designed to have a sealed cylindrical shape as shown in FIGS. 14(a) and 14(b) and plays the role of feeding the spinning liquid in a drop shape continuously introduced from the spinning liquid main tank 1 to the nozzle block 4.

The spinning liquid dropping device 3 has an overally sealed cylindrical shape as shown in FIGS. 14(a) and 14(b). FIG. 14(a) is a cross sectional view of the spinning liquid dropping device and FIG. 14(b) is a perspective view of the spinning liquid dropping device.

A spinning liquid induction pipe 3c for inducting a spinning liquid toward the nozzle block and an gas inlet pipe 3b are arranged side by side on the upper end of the spinning liquid dropping device 3. At this time, it is preferred to form the spinning liquid induction pipe 3c slightly longer than the gas inlet pipe 3b.

Gas is introduced from the lower end of the gas inlet pipe, and the portion at which gas is firstly introduced is connected to a filter 3a. A spinning liquid discharge pipe 3d for inducting a dropped spinning liquid to the nozzle block 4 is formed on the lower end of the spinning liquid dropping device 3. The middle part of the spinning liquid dropping device 3 is formed in a hollow shape so that the spinning liquid can be dropped at the tip of the spinning liquid induction pipe 3c.

The spinning liquid introduced to the spinning liquid dropping device 3 flows down along the spinning liquid induction pipe 3c and then dropped at the tip thereof, to thus block the flow of the spinning liquid more than once.

The principle of the dropping of the spinning liquid will be described concretely. If gas is introduced to the upper end of the sealed spinning liquid dropping device 3 along the filter 3a and the gas inlet pipe 3b, the pressure of the spinning liquid induction pipe 3c becomes naturally non-uniform by a gas eddy current or the like. Due to a pressure difference generated at this time, the spinning liquid is dropped.

In the present invention, as the gas to be introduced, can be used air, inert gases such as nitrogen, etc.

The entire nozzle block 4 bilaterally reciprocates perpendicular to the traveling direction of nanofibers electrospun by a nozzle block bilateral reciprocating device 10 in order to make the distribution of electrospun nanofibers uniform.

Further, in the nozzle block, more concretely, in the spinning liquid main feed plate 4f, a stirrer 11c stirring the spinning liquid being stored in the nozzle block 4 is installed in order to prevent the spinning liquid from gelling.

The stirrer 11c is connected to a motor 11a by a nonconductive insulating rod 11b.

Once the stirrer 11c is installed in the nozzle block 4, it is possible to prevent the gelation of the spinning liquid in the nozzle block 4 effectively when electrospinning a liquid containing an inorganic metal or when electrospinning the spinning liquid dissolved with a mixed solvent for a long time.

Additionally, a spinning liquid discharge device 12 is connected to the uppermost part of the nozzle block 4 for forcedly feeding the spinning liquid excessively fed into the nozzle block to the spinning liquid main tank 1.

The spinning liquid discharge device 12 forcedly feeds the spinning liquid excessively fed into the nozzle block to the spinning liquid main tank 1 by a suction air or the like.

Further, a heating device (not shown) of direct heating type or indirect heating type is installed (attached) to the collector 7 of the present invention, and the collector 7 is fixed or continuously rotates.

The nozzles 5 located on the nozzle block 4 are arranged on a diagonal line or a straight line.

### ADVANTAGEOUS EFFECT

The present invention is capable of making a continuous filament consisting of nanofibers by a simpler continuous process. The continuous filament made according to the present invention is improved much in physical property and thus useful as materials for various fields of industry such as artificial dialysis filter, artificial vessel, adhesion preventive agent, artificial bone, etc. as well as daily necessaries such as artificial leather, air cleaning filter, wiping cloth, golf glove, wig, etc.

### BEST MODE FOR CARRYING OUT THE INVENTION

The present invention is now understood more concretely by comparison between examples of the present invention and comparative examples. However, the present invention is not limited to such examples.

### Example 1

Poly(ε-caprolacton) polymer (manufactured by Aldrich, USA) with a number average molecular weight of 80,000 was dissolved in a mixed solvent of methylene chloride/N,N-dimethylformamide (volume ratio: 75/25) at a concentration of 13% by weight, to thereby obtain a polymer spinning liquid.

The surface tension of the polymer spinning liquid was 35 mN/m, the solution viscosity was 250 centipoises under a room temperature, the electric conductivity was 0.02 mS/m and permittivity constant was 90. The polymer spinning liquid was electrostatically spun to a collector 7 located on the top part through a nozzle block 4, with nozzles having a 1 mm diameter arranged thereto in a row, via a metering pump 2 as shown in FIG. 1, thereby making a nanofiber web with a unit width of 2.5 cm. At this time, as the nozzle block 4, used was a nozzle block which consists of ten unit nozzle blocks each having 80 nozzles arranged thereto in a row in a traveling direction of nanofibers and which has a total of 800 nozzles. The throughput rate per nozzle was 1.6 mg/min.

Further, as the collector 7, used was a collector having barriers 7b of Teflon installed at a 3 cm interval.

Further, in electrospinning, the nozzle block 4 was bilaterally reciprocated at a velocity of 3 m/min by using a nozzle block bilateral reciprocating device 10, and the collector 7 was heated at 35° C.

Further, in electrospinning, the voltage was 30 kV and the spinning distance was 20 cm.

Continually, the nanofiber web 17a thus made was fed between web feed rollers 14 and 15 having a rotation linear velocity of 64.2 m/min, and discharged by applying a voltage of 15 kV to a discharge device 9b.

In the above discharging treatment, the distance h from the collector to the discharge device was 2.5 m and an electrode opposite to that applied in electrospinning was applied.

Continually, the discharged nanofiber web 17a was passed through an air twister 18 and twisted, thereby making a nanofiber filament 17b of a continuous filament form. At this time, an air pressure supplied to the air twister was 2 kg/cm² and a number of twists was 60 turns/m.

Continually, the nanofiber filament 17b thus made was passed between a first roller 19 and a second roller 20 and drawn at an elongation of two times.

Then, it was passed between the second roller 20 and a third roller 22, heat-treated at 35° C., and taken up to make a final nanofiber filament.

At this time, the rotation linear velocity of the first roller 19 was 64.2 m/min.

The nanofiber filament thus made had a fineness of 75 deniers, a strength of 1.3 g/d and an elongation of 32%. Further, an electron micrograph of the surface of the nanofiber filament was shown in FIG. 11.

### Example 2

Polyurethane resin (manufactured by Daewoo International, Korea) with a number average molecular weight of 80,000 and polyvinyl chloride (LG Chemical, Korea) with a polymerization degree of 800 was dissolved in a mixed solvent of dimethylformamide/tetrahydrofuran (volume ratio: 5/5) at a weight ratio of 70/30, to thereby obtain a 12.5% by weight polymer spinning liquid. The viscosity of the spinning liquid was 450 centipoises.

The polymer spinning liquid was electrostatically spun to a collector 7 located on the top part through a nozzle block 4, with 400 nozzles having a 1 mm diameter diagonally arranged thereto, via a metering pump 2 as shown in FIG. 4, thereby making a wide nanofiber web with a 60 cm width.

At this time, the throughput rate per nozzle was 2.0 mg/min. In electrospinning, the nozzle block 4 was bilaterally reciprocated at a velocity of 2.5 m/min by using a nozzle block bilateral reciprocating device 10, and the collector 7 was heated at 85° C.

Further, in electrospinning, the voltage was 30 kV and the spinning distance was 25 cm.

Continually, the nanofiber web thus made was fed between web feed rollers 14 and 15, and discharged by a discharge device 9b and at the same time cut to a 2.0 cm interval by a web cutter 16 with a rotary blade attached thereto, thereby making 30 nanofiber webs having a width of 2 cm.

In the above discharging treatment, a voltage of 25 kV was applied to the discharge device 9b, the distance h from the collector to the discharge device was 2.5 m, and an electrode opposite to that applied in electrospinning was applied.

Further, the rotation linear velocity of the web feed rollers 14 and 15 was 30 m/min.

Continually, the discharged nanofiber web 17a cut and discharged as above was passed through an air twister 18 and twisted, thereby making a nanofiber filament 17b of a continuous filament form. At this time, an air pressure supplied to the air twister was 2 kg/cm² and a number of twists was 45 turns/m.

Continually, the nanofiber filament 17b thus made was passed between a first roller 19 and a second roller 20 and drawn at an elongation of 1.2 times. Then, it was passed between the second roller 20 and a third roller 22 and taken up to make a final nanofiber filament.

At this time, the rotation linear velocity of the first roller 19 was 30 m/min.

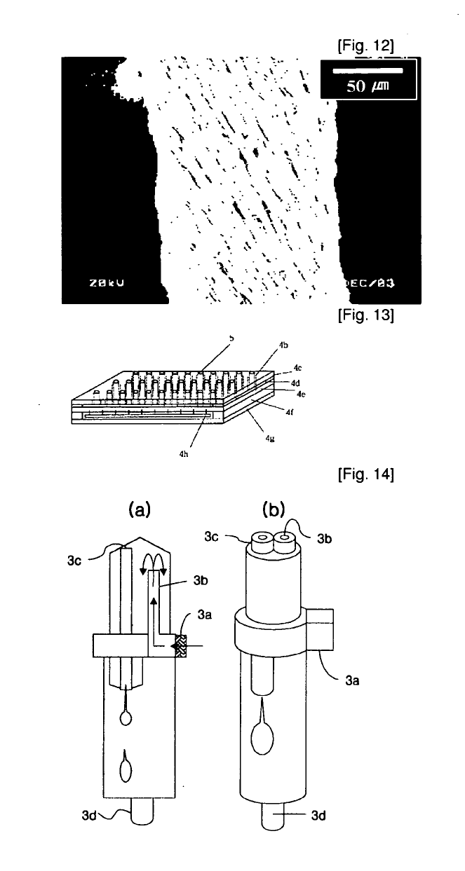

The nanofiber filament thus made had a fineness of 120 deniers, a strength of 1.4 g/d and an elongation of 50%. Further, an electron micrograph of the surface of the nanofiber filament was shown in FIG. 12.

### Example 3

Nylon 6 resin having a relative viscosity of 3.2 was dissolved in formic acid at a concentration of 15% by weight to prepare a spinning liquid. The surface tension of the polymer spinning liquid was 49 mN/m, the solution viscosity was 1,150 centipoises under a room temperature, and the electric conductivity was 420 mS/m.

The polymer spinning liquid was electrostatically spun to a collector 7 located on the top part through a nozzle block 4, with nozzles having a 1 mm diameter arranged thereto in a row, via a metering pump 2 as shown in FIG. 1, thereby making a nanofiber web with a unit width of 1.8 cm.

At this time, as the nozzle block 4, used was a nozzle block which consists of ten unit nozzle blocks each having 100 nozzles arranged thereto in a row in a traveling direction of nanofibers and which has a total of 1000 nozzles. The throughput rate per nozzle was 1.2 mg/min.

Further, as the collector 7, used was a collector having barriers 7b of Teflon installed at a 2.5 cm interval.

Further, in electrospinning, the nozzle block 4 was bilaterally reciprocated at a velocity of 3 m/min by using a nozzle block bilateral reciprocating device 10, and the collector 7 was heated at 35° C.

Further, in electrospinning, the voltage was 30 kV and the spinning distance was 15 cm.

Continually, the nanofiber web 17a thus made was fed between web feed rollers 14 and 15 having a rotation linear velocity of 50 m/min, and discharged by applying a voltage of 20 kV to a discharge device 9b.

In the above discharging treatment, the distance h from the collector to the discharge device was 3.5 m and an electrode opposite to that applied in electrospinning was applied.

Continually, the discharged nanofiber web 17a was passed through an air twister 18 and twisted, thereby making a nanofiber filament 17b of a continuous filament form. At this time, an air pressure supplied to the air twister was 3 kg/cm² and a number of twists was 80 turns/m.

Continually, the nanofiber filament 17b thus made was passed between a first roller 19 and a second roller 20 and drawn at an elongation of two times. Then, it was passed between the second roller 20 and a third roller 22, heat-treated at 90° C., and taken up to make a final nanofiber filament.

At this time, the rotation linear velocity of the first roller 19 was 50 m/min.

The nanofiber filament thus made had a fineness of 75 deniers, a strength of 3.0 g/d and an elongation of 36%.

What is claimed is:

1. A process of preparing a continuous filament composed of nanofibers, wherein a polymer spinning liquid is electrospun to a collector 7 through nozzles 5 to obtain a nanofiber web 17a of ribbon form, then the nanofiber web 17a is passed through an air twister 18 and twisted to obtain a nanofiber filament 17b of a continuous filament form, and then the nanofiber filament 17b is drawn.

2. The process of claim 1, wherein the nanofiber web 17a of ribbon form is obtained by electrospinning in a manner that the width of the nanofiber web 17a is the same as the overall width of the collector 7 and then cutting the nanofiber web by a web cutter 16.

3. The process of claim 2, wherein the web cutter 16 consists of a rotary blade 16a and a motor 16b rotating the rotary blade.

4. The process of claim 1, wherein the nanofiber web 17a of ribbon form is obtained by electrospinning in narrow sections in a manner the width of the nanofiber web 17a is the same as the width of one nozzle block 4.

5. The process of claim 4, wherein a collector 7 with barriers 7b installed thereto at the same distance as the width of one nozzle block 4 is used in electrospinning.

6. The process of claim 1, wherein the air twister 18 is provided with a passage of the nanofiber web 17a and an air outlet formed at the center along the longitudinal direction and an air inlet formed in a direction perpendicular or inclined to the air outlet.

7. The process of claim 1, wherein the electrospinning type is upward electrospinning type, downward electrospinning type or horizontal electrospinning type.

8. The process of claim 1, wherein a nanofiber web separating film or a nonwoven fabric 24 is continuously fed onto the surface of the collector 7 where nanofibers are electrostatically spun.

9. The process of claim 1, wherein a nanofiber web separating solution 27 is continuously or discontinuously coated or sprayed onto the collector 7 where nanofibers are electrostatically spun.

10. The process of claim 9, wherein the nanofiber web separating solution 27 is water, a cationic surfactant, an anionic surfactant, an amphoteric (cationic-anionic) surfactant, or a neutral surfactant.

11. The process of claim 9, wherein the web separating solution 27 is methanol, ethanol, toluene or methylene chloride.

12. The process of claim 1, wherein the nanofiber filament 17b is drawn between two rollers by using a gap in rotation linear velocity between the rollers.

13. The process of claim 1, wherein more than two kinds of nanofiber webs of ribbon form obtained by electrostatically spinning more than two kinds of spinning liquids are passed through one air twister 18.

14. The process of claim 1, wherein the drawn nanofiber filament 17b is heat treated.
